(19) United States
(12) Patent Application Publication
(10) Pub. No.: US 2018/0243890 A1
(43) Pub. Date: Aug. 30, 2018

(54) Bladed Tools for Auto Glass Removal

(71) Applicant: Rammer Jammer Tools LLC, Chandler, AZ (US)

(72) Inventors: Clint R. Hudlin, Chandler, AZ (US); Jacob Tanner Hudlin, Chandler, AZ (US)

(73) Assignee: Rammer Jammer Tools LLC, Chandler, AZ (US)

(21) Appl. No.: 15/898,859

(22) Filed: Feb. 19, 2018

Related U.S. Application Data
(60) Provisional application No. 62/465,038, filed on Feb. 28, 2017.

(51) Int. Cl. B25B 27/00

(52) U.S. Cl. CPC B25B 27/0092; B62D 67/00; B25B 27/0028; B25B 27/0035

(57) ABSTRACT

A set of tools for removing a vehicle window includes a first tool, a second tool, and a third tool. The first tool includes a first shaft comprising a substantially flat profile, a first blade attached to the first shaft, and a first handle attached to the first shaft opposite the first blade. The second tool includes a second shaft comprising a substantially flat profile and a second blade attached to the second shaft. A second length of the second tool is longer than a first length of the first tool. The third tool includes a third shaft comprising a substantially flat profile and a third blade attached to the third shaft. A third length of the third tool is longer than the second length of the second tool.

### CLAIM TO DOMESTIC PRIORITY

The present application claims the benefit of U.S. Provisional Application No. 62/465,038, filed Feb. 28, 2017, which application is incorporated herein by reference.

### FIELD OF THE INVENTION

The present invention relates in general to auto body tools, and, more particularly, to bladed tools for auto glass removal.

### BACKGROUND OF THE INVENTION

Auto body shops and amateur home mechanics alike commonly desire to remove a glass panel from a vehicle being worked on. Removing auto glass is a risky endeavor because accidentally breaking the window can quickly increase the cost of repair by hundreds of dollars. Removal of windows that are attached to the vehicle by a urethane adhesive, e.g., windshields and quarter glass, are particularly challenging. The urethane seal must be broken without damage to the vehicle body or window.

The Internet is packed with tips and tricks for removing auto glass. Gimmicky tools abound, which work but are challenging to use or have serious potential to break the glass and cause other damage to the vehicle. A need exists for an auto glass removal tool that is simple to use and reduces the risks of vehicle damage associated with auto glass work.

### BRIEF DESCRIPTION OF THE DRAWINGS

FIGS. 1a-1c illustrate a set of bladed tools;

FIGS. 2a and 2b illustrate blade options for the tools;

FIGS. 3a-3c illustrate a shaft for the tools;

FIGS. 4a and 4b illustrate a handle for the tools;

FIG. 5 illustrates a handle attached to a shaft during manufacturing of one of the tools;

FIGS. 6a-6c illustrate a blade attached to a shaft during manufacturing of one of the tools;

FIG. 7 illustrates a finished tool;

FIG. 8 illustrates a brace added to support the blade of one of the tools;

FIGS. 9a-9l illustrate removing a vehicle's quarter glass using the tools; and

FIGS. 10a-10c illustrate additional uses for the tools.

### DETAILED DESCRIPTION OF THE DRAWINGS

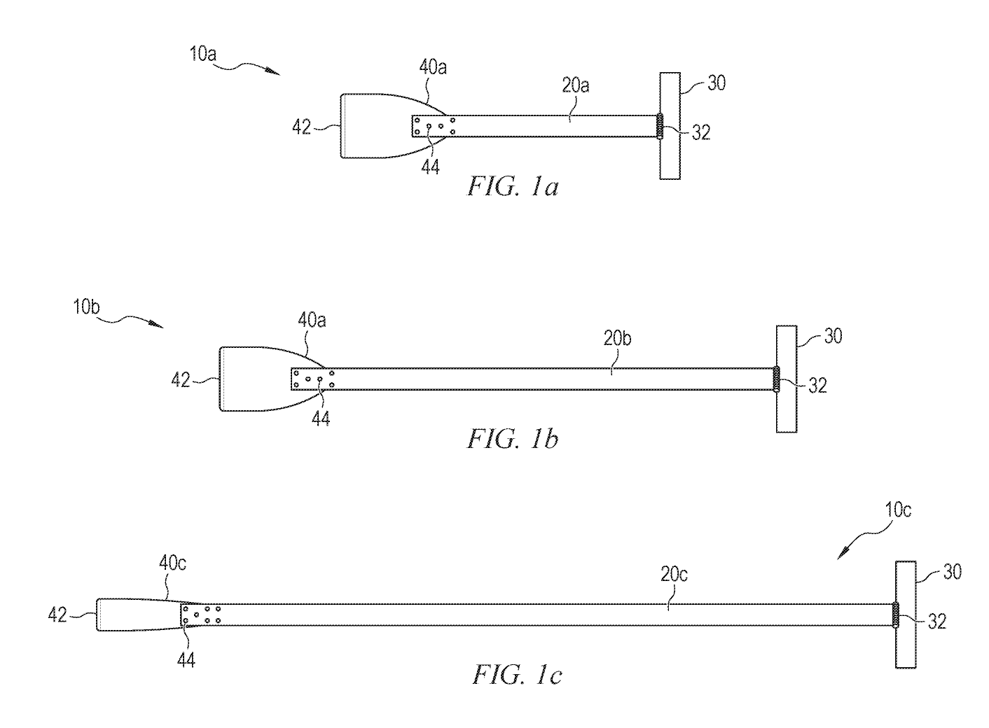

FIGS. 1a-1c illustrate a set of bladed tools 10a, 10b, and 10c, adapted to remove auto glass. Each of the tools 10a, 10b, and 10c are constructed from similar parts and in a similar manner. The differences between the tools 10a, 10b, and 10c are in their dimensions, or the dimensions of their constituent parts. The tools 10a, 10b, and 10c are configured such that each of the tools is particularly useful in different situations. Tools 10a-10c are sold either individually or as a set. In combination, the three tools illustrated are able to remove substantially any piece of auto glass that is mounted onto the auto body by a urethane seal. Therefore, buying the set of tools 10a, 10b, and 10c gives the user the ability to remove just about any vehicle window. Tools with different dimensions can be manufactured as desired for a given window to be removed.

Each tool 10 includes a shaft 20, a handle 30, and a blade 40. Shaft 20 is formed into a relatively flat rectangle by extrusion, drawing, by cutting a strip from a large flat sheet of material, or by other appropriate means. Shaft 20 is formed of mixed steel, stainless steel, other steel alloys, aluminum, copper, titanium, alloys thereof, or another appropriate metallic or non-metallic material.

FIG. 1a illustrates a shorter shaft 20a. FIG. 1b illustrates an intermediate length shaft 20b, and FIG. 1c illustrates a longer shaft 20c. In one embodiment, shaft 20a includes a length of 14 inches, shaft 20b includes a length of 23 inches, and shaft 20c includes a length of 32 inches. Shorter shaft 20a is convenient in cases where the tool needs to be maneuvered into a smaller space for removal of auto glass, e.g., a door opening. Intermediate length shaft 20b is useful for breaking urethane seals of window edges further from the door opening. Longer shaft 20c is useful in cases where an auto glass seal is in a hard to reach location, e.g., the bottom of a windshield from the inside of a vehicle or the top of a windshield from the sides of the vehicle. Utilizing a shaft 20 of appropriate length for a given situation reduces the likelihood of damage to a vehicle because maintaining control of the tool is easier.

The flat profile of shaft 20 allows the tools to reach further into spaces of a vehicle that thin down to a window seal, such as the bottom of a windshield where the dashboard meets the windshield. The flat profile also allows the tool to be slipped in between a window and a vehicle once the urethane seal has been breached, to continue breaking the seal further along the window edge. Having a flat profile to shaft 20 reduces the gap size between the window and vehicle that must be provided to insert the tool relative to other shaft shapes, e.g., cylindrical. The thin profile also helps reduce damage to vehicles by being easier to fit into different areas of the car, while the shaft remains further away from the vehicle. A cylindrical shaft would be more likely to impact and break the window being removed, or scratch the vehicle's paint.

Each of the tools 10 includes a handle 30 attached to one end of shaft 20. Handles 30 are easily graspable by a human hand for use of tools 10, and are also configured to receive impact force from a hand, hammer, or other tool to help break the urethane seal of a window. Handles 30 are illustrated as cylinders oriented perpendicularly to the length of shafts 20 and parallel to the width of the shafts. In one embodiment, handle 30 is a cylindrical rod with a circular or elliptical cross section. In another embodiment, handle 30 has a square or rectangular cross section. Handle 30 can be a knob, have a contoured grip, or be made in any other handle shape. Handle 30 is oriented in parallel with shaft 20 in some embodiments, and can simply be a portion of shaft 20 shaped into a handle. Handles 30 are formed by extrusion, drawing, molding, grinding, or otherwise forming a piece of material into the desired shape. Handles 30 are formed from steel, iron, aluminum, copper, titanium, alloys thereof, or other suitable metallic or non-metallic materials.

Handles 30 are attached to shafts 20 by a weld joint 32. Weld joint 32 is formed in the process of welding handle 30 to shaft 20. Welding can be performed by stick welding, MIG welding, TIG welding, oxy-fuel welding, soldering, or other appropriate mechanisms for mechanically joining workpieces. The length of handle 30 is between 3 and 5 inches in one embodiment, while the diameter or thickness of the handle is between 0.25 and 1 inch. Handles 30 are manufactured in any desired dimensions, including a length of the handle in some embodiments that is the same as, or shorter than, the width of shaft 20. In other embodiments, handle 30 is absent, and tool 10 is used by directly manipulating shaft 20 by, e.g., holding the shaft in a user's hand or hitting end of the shaft with a hammer.

A blade 40 is attached to a second end of shaft 20 of each tool 10, opposite handle 30. The lengths of shaft 20 and blade 40 run parallel to a line from handle 30 to blade 40, i.e., left to right in FIGS. 1a-1c, while the widths of the blade and shaft run up and down in FIGS. 1a-1c. The thicknesses of shaft 20 and blade 40 run into and out of FIGS. 1a-1c. Blades 40a are approximately 3 inches wide, while blade 40c is approximately 1.5 inches wide. In some embodiments, blades 40 are manufactured to between 1 and 4 inches wide, between 0.03 and 0.11 inches thick, and between 1 and 10 inches long. Any suitable dimensions and shapes for blade 40 are used in other embodiments.

Blade 40 is a relatively flat sheet of metal. Blade 40 is formed from iron, steel, aluminum, copper, brass, titanium, alloys thereof, or another suitable metallic or non-metallic material. Each of the blades includes a sharpened tip 42 at the end of the blade opposite shaft 20. Sharpened tip 42 facilitates inserting tools 10 between a window and a car body by cutting through the urethane seal. Blades 40 can be purchased sharpened from the manufacturer, or the blades can be sharpened by a user. The blades can also be sharpened periodically as desired to maintain a satisfactory tip 42.

Blades 40 are attached to shaft 20 by spot welds 44 or another suitable attachment mechanism. Spot welding applies mechanical pressure to a spot to be welded between a pair of electrodes, and generates heat by forcing a large electrical current through the spot. The heat and pressure fuse the two workpieces together. Blade 40 is spot welded to shaft 20 at a plurality of locations 44 to improve strength of the bond. Each separate location 44 where a spot weld was performed is visible as a separate circle where the electrodes of the spot weld machine applied force. While particular patterns for spot welds 44 are illustrated, other suitable patterns can be used in other embodiments. Blade 40 can be MIG welded, TIG welded, stick welded, oxy-fuel welded, soldered, riveted, glued, or otherwise mechanically attached to shaft 20. Blade 40 is removably attached in some embodiments, e.g., by inserting a blade into an opening of the shaft with a latching mechanism to hold the blade in the shaft.

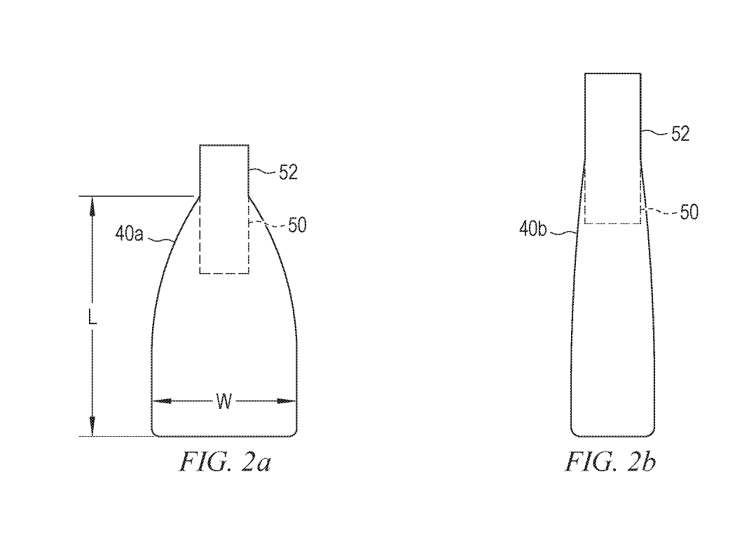

FIGS. 2a and 2b illustrate possible shapes for blade 40. Blades 40 can be cut into any desired shape from a piece of sheet metal by laser cutting, water cutting, by cutting with a saw, or another suitable method. Each of the blades 40 includes a region 50 reserved for attachment of shaft 20. Region 50 illustrates where the lengths of blade 40 and shaft 20 overlap for spot welding. Region 50 can be larger or smaller in other embodiments. Larger regions 50 allow room for additional spot welds 44 for added strength of the bond between blade 40 and shaft 20. Smaller regions 50 allow tool 10 to be made smaller.

Blades 40 include a tab 52 that extends the amount of area 50 available to weld a shaft 20 to the blade. A tab 52 can be used with any blade 40 configuration to provide extra space for welding. In other embodiments, region 50 does not extend above the point where the sides of the blades 40 meet region 50, i.e., tabs 52 are optional. In some embodiments, blades 40 include other features allowing for attachment of the blades to shaft 20, e.g., an opening in tab 52 to interface with a latch in shaft 20.

FIG. 2a illustrates blade 40a from FIGS. 1a and 1b. Blade 40a is approximately six to eight inches long and approximately three inches wide in one embodiment. FIG. 2b illustrates blade 40c from FIG. 1c. Blade 40c is the same length as blade 40a at around 6-8 inches, but only half as wide at about 1.5 inches. The reduced width of blade 40c allows use of the blade in corners of windows where the wider blades 40a may not fit. The reduced width of blade 40c also allows the blade to more easily flex. Flex of the blade allows the blade to be used in awkward situations where there is inadequate clearance to the window seal. In other embodiments, shorter blades are used which provide less flex, but allow for greater control of the tool. While two specific blade designs are illustrated in FIGS. 2a and 2b, any other appropriate blade shape is usable in other embodiments.

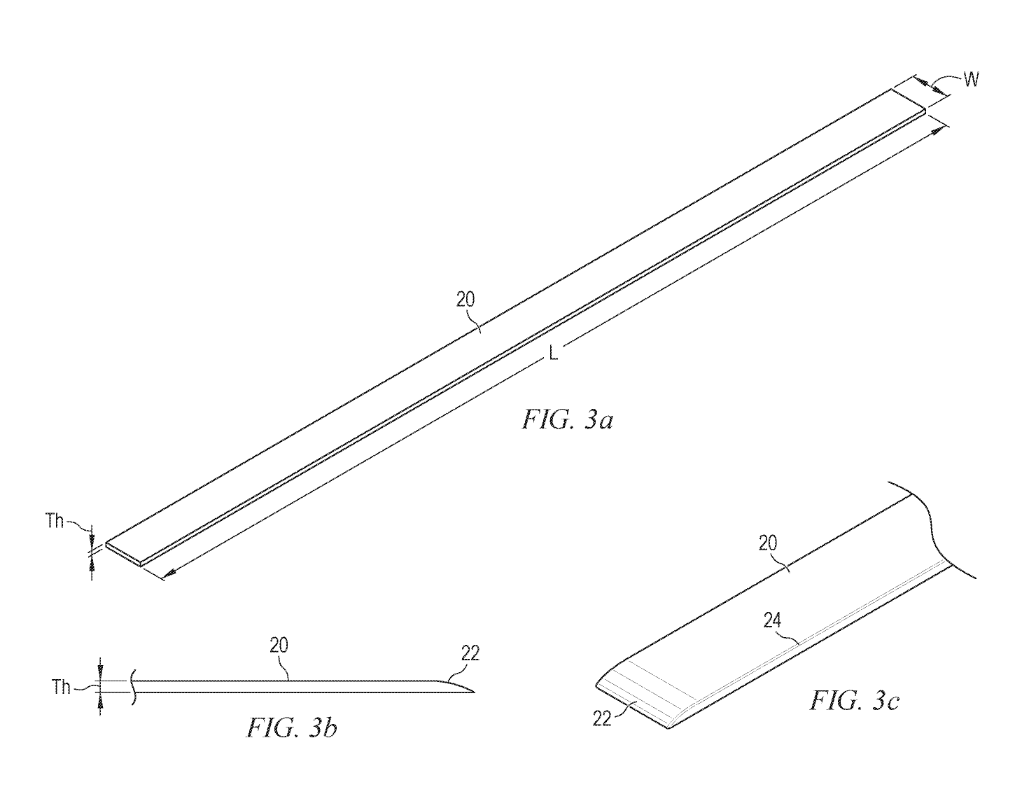

FIG. 3a illustrates a shaft 20. Shaft 20 is a rectangular box shape with a length indicated by the L axis, a width indicated by the W axis, and a thickness indicated by Th. In one embodiment, a thickness of shaft 20 is between a 0.1 and 0.25 inches, a width of the shaft is between 0.75 and 1.5 inches, and a length of the shaft is between 4 inches and 36 inches.

Shaft 20 can be extruded through a rectangular hole dimensioned with the desired width and thickness for the shaft. The extrusion is then cut to the desired length. In another embodiment, a piece of sheet metal with the desired shaft 20 thickness is cut into rectangles with the desired length and width for the shaft. In other embodiments, shaft 20 can be a cylinder or other shape, include any suitable dimensions, and be formed using any suitable method.

FIGS. 3b and 3c illustrate a shaft 20 with an end 22 of the shaft that has been rounded. End 22 is rounded on top but remains flat on the bottom. A blade 40 is attached to the flat bottom of shaft 20. Having a rounded surface of shaft 20 extending over blade 40 reduces the likelihood that the shaft will cause damage when contacting the vehicle's window or body because a smooth surface is presented instead of a sharp corner.

End 22 is rounded using an angle grinder or other appropriate tool to remove a portion of the material of shaft 20. In another embodiment, end 22 is rounded by using forging or another metalworking process to mechanically deform the end into a rounded shape. In some embodiments, lengthwise edges 24 are also rounded. Edges 24 can be rounded by using an extrusion die with rounded corners. In other embodiments, edges 24 are rounded using the same metalworking process that forms rounded end 22. In some embodiments, edges 24 are rounded toward end 22 but remain squarer away from end 22. End 22 and edges 24 can be rounded either before or after attaching blade 40 to shaft 20.

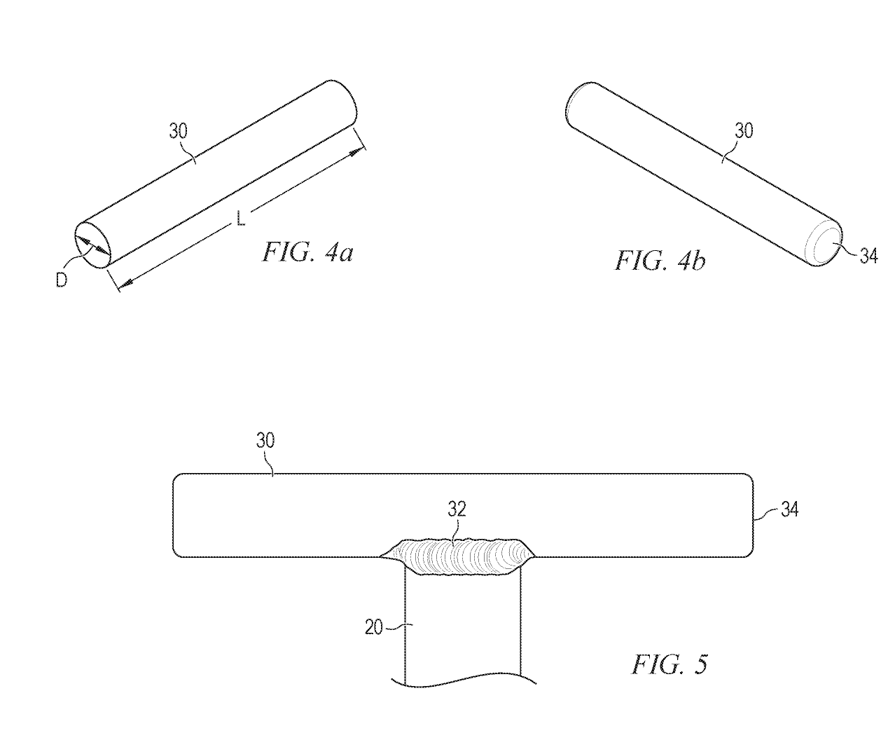

FIG. 4a illustrates a handle 30 for tools 10. Handle 30 is a cylindrical metal rod formed by extrusion, drawing, rolling, or another suitable process and cut to a desired length. A length of handle 30 is indicated by the L dimension of FIG. 4a, and a diameter or thickness of the handle is indicated by the D dimension. Handle 30 is shaped to improve grip in some embodiments, e.g., by adding texture to the cylindrical surface or shaping the cylinder length to add finger grips. In FIG. 4b, ends 34 of handle 30 are given an optional bevel. Ends 34 can also be rounded as in FIG. 5. Beveled or rounded ends 34 reduce the sharpness of the ends for comfort of the user and to reduce damage due to vehicle contact with the handle.

FIG. 5 illustrates handle 30 attached to shaft 20. Weld joint 32 is a region where the welding process melted the material of handle 30 and shaft 20 together. Weld joint 32 fixes the positions of handle 30 and shaft 20 relative to each other. In some embodiments, handle 30 includes a slot to insert shaft 20 for alignment. In other embodiments, shaft 20 is inserted through a slot extending completely through handle 30 and welded on both sides of the handle for added strength. In one embodiment, handle 30 is attached to shaft 20 by a mechanism other than welding.

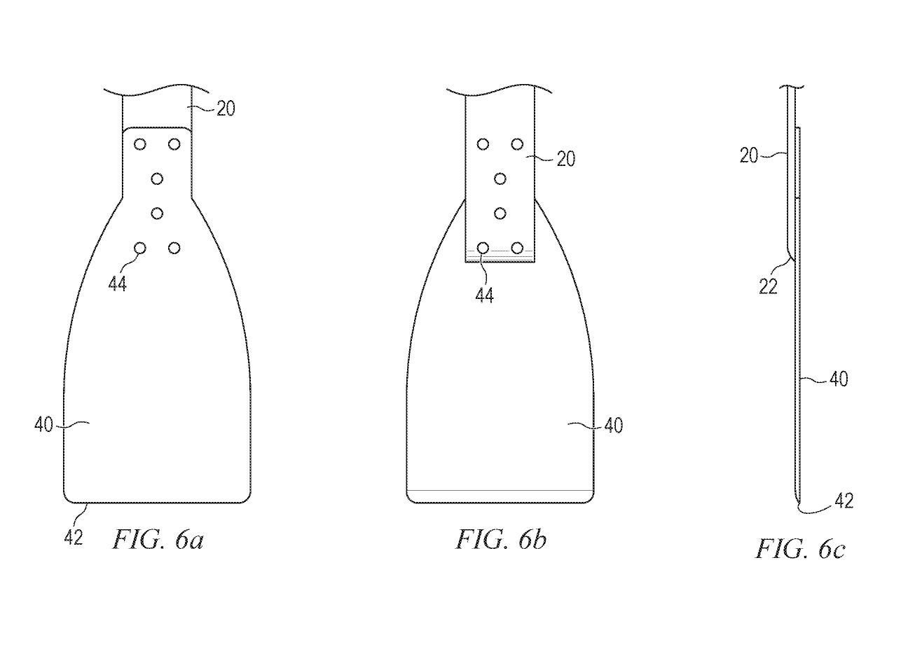

FIGS. 6a-6c illustrate blade 40 attached to shaft 20 by spot welds 44. FIG. 6a illustrates a view from the blade 40 side of spot welds 44, FIG. 6b from the shaft 20 side, and FIG. 6c is a side angle. Any suitable number and pattern of spot welds 44 can be used to attach blade 40 to shaft 20. FIGS. 6b and 6c illustrate that the rounded side of end 22 faces away from blade 40. The sharpened edge 42 of blade 40 is oriented away from handle 30 so that a user holding the handle can use edge 42 to cut through a urethane seal. Edge 42 can be sharpened before or after blade 40 is attached to shaft 20. Edge 42 can be sharpened on the same side of blade 40 that shaft 20 is attached to, the opposite side, or both sides can be sharpened so that sharpened edge 42 is approximately centered in the thickness of blade 40. Blade 40 can be attached to shaft 20 before or after handle 30 is attached.

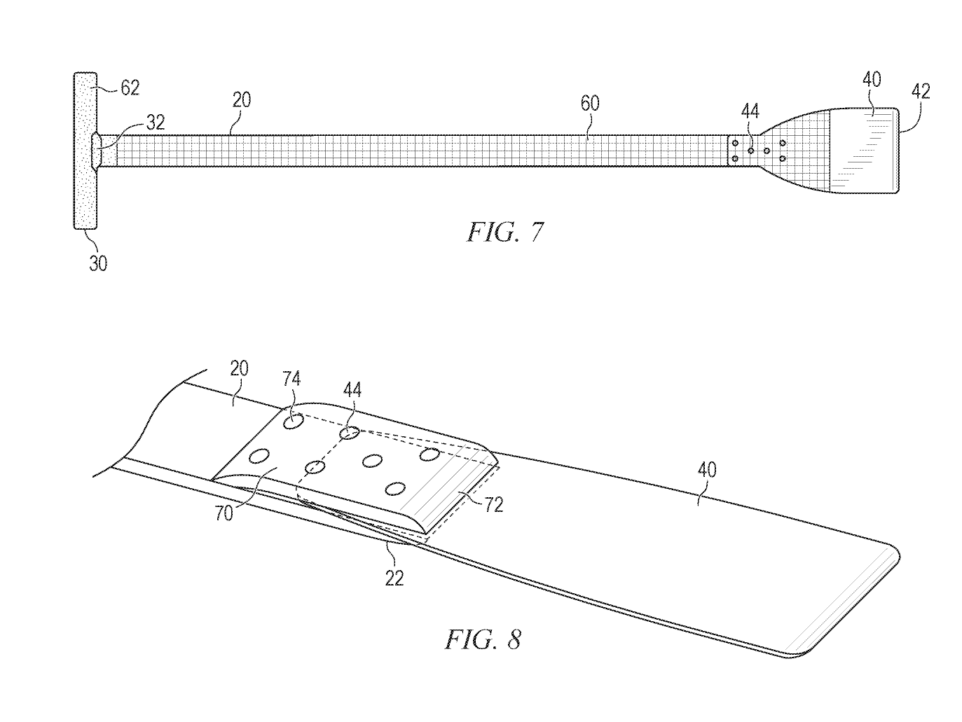

After handle 30 and blade 40 are attached to shaft 20, the tools can be finished for an improved appearance as shown in FIG. 7. The entirety of tool 10 can be given a brushed steel finish for looks, or to promote adherence of subsequently applied paint. In FIG. 7, the majority of shaft 20 and a portion of blade 40 are covered in a coat of paint 60. Paint 60 can be any desirable color or pattern. Paint 60 can be applied by painting with a brush or roller, sprayed on, or powder coated. Additional logos and branding can be added as desired by painting, applying stickers, etc.

Handle 30 is given an optional textured coating 62 to aid in grip. Textured coating 62 includes paint with polypropylene beads or another additive that increases friction between handle 30 and the hand of a user. The portion of blade 40 not coated in paint 60 remains exposed as a brushed finish. In other embodiments, other coatings or other finishes are used for the different parts of tools 10. In one embodiment, handle 30 is knurled before or after attachment to shaft 20 to provide grip. Handle 30 can be covered in paint coating 60 if desired.

FIG. 8 illustrates an optional brace 70 added to strengthen the mechanical bond between blade 40 and shaft 20. Brace 70 is a metal piece similar to shaft 20, but generally smaller in length. Brace 70 is disposed on blade 40 opposite shaft 20. Spot welds 44 are formed through all three of shaft 20, blade 40, and brace 70. Brace 70 includes a rounded end 72 oriented toward sharpened edge 42 of blade 40. Rounded end 72 of brace 70 is formed similarly to rounded end 22 of shaft 20, and for similar reasons. The end of brace 70 opposite end 72 extends past blade 40. Extra spot welds 74 are provided that connect brace 70 directly to shaft 20 outside the footprint of blade 40. Shaft 20 and brace 70 contact each other at spot welds 74. Brace 70 gives extra mechanical strength to the bond between blade 40 and shaft 20 to increase reliability of tools 10. Brace 70 is compatible with any of the disclosed configurations for tools 10. Paint coating 60 can be applied over brace 70.

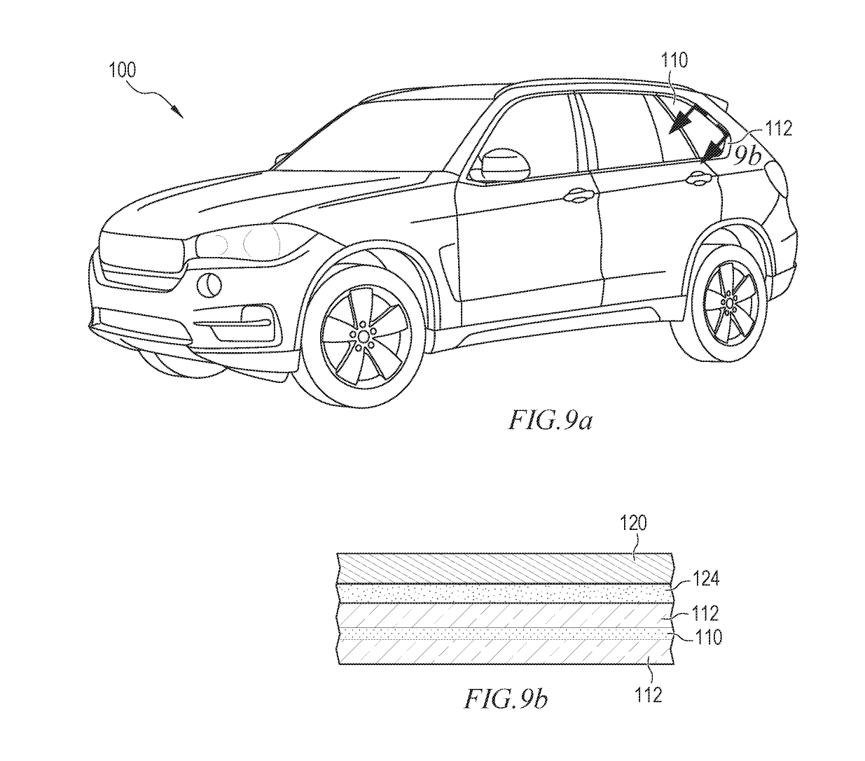

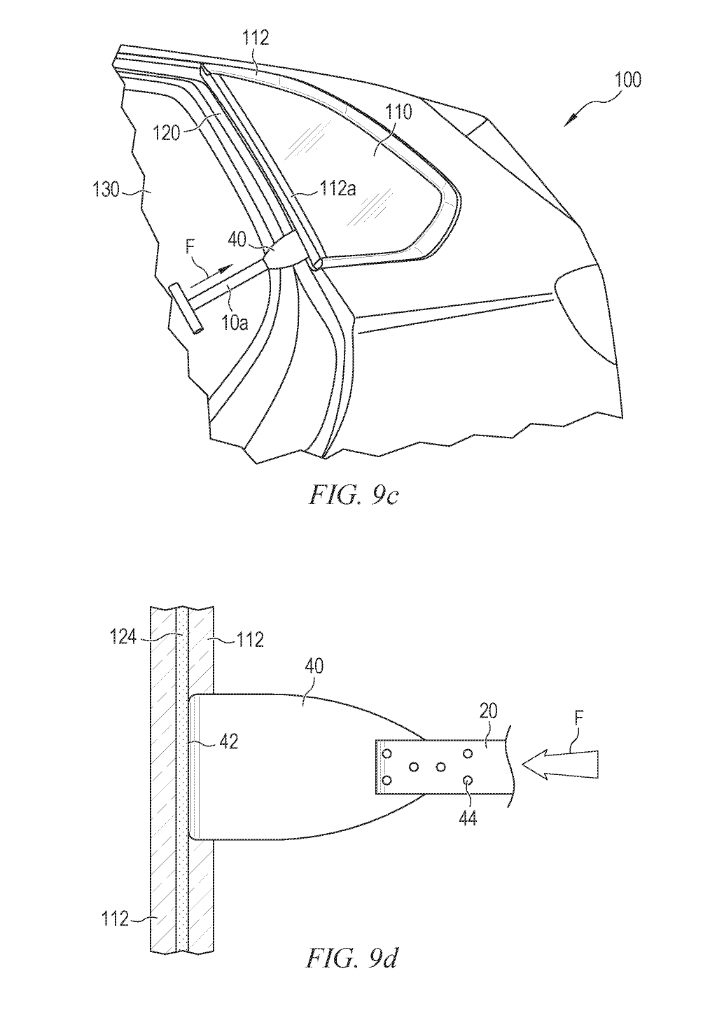

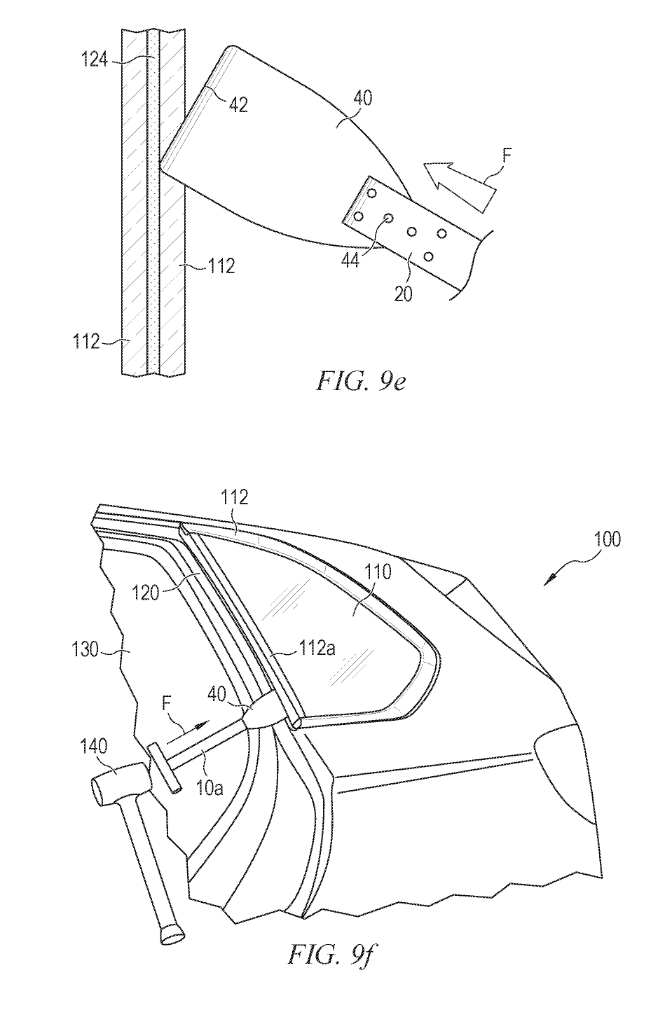

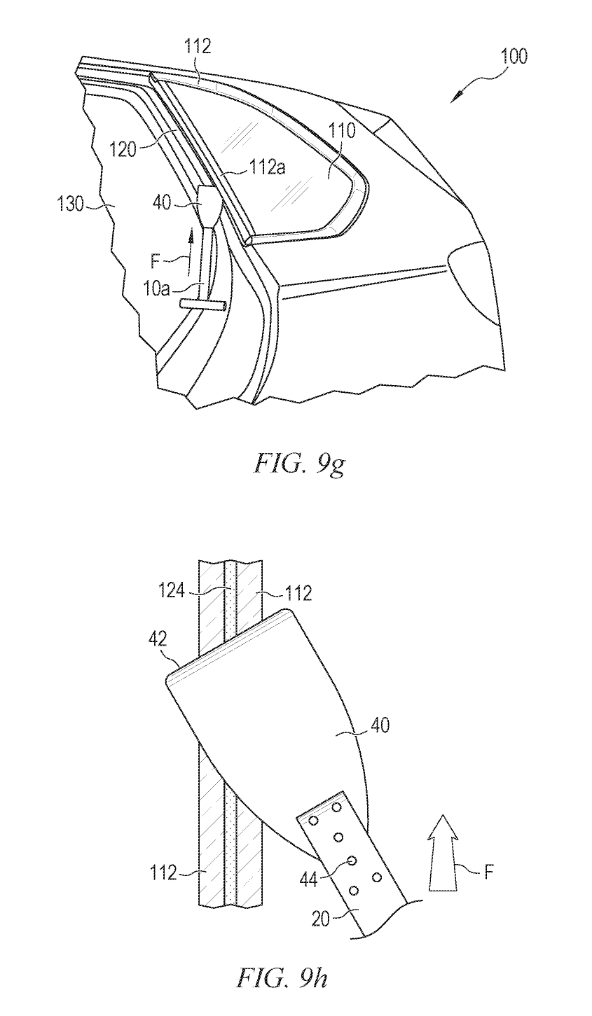

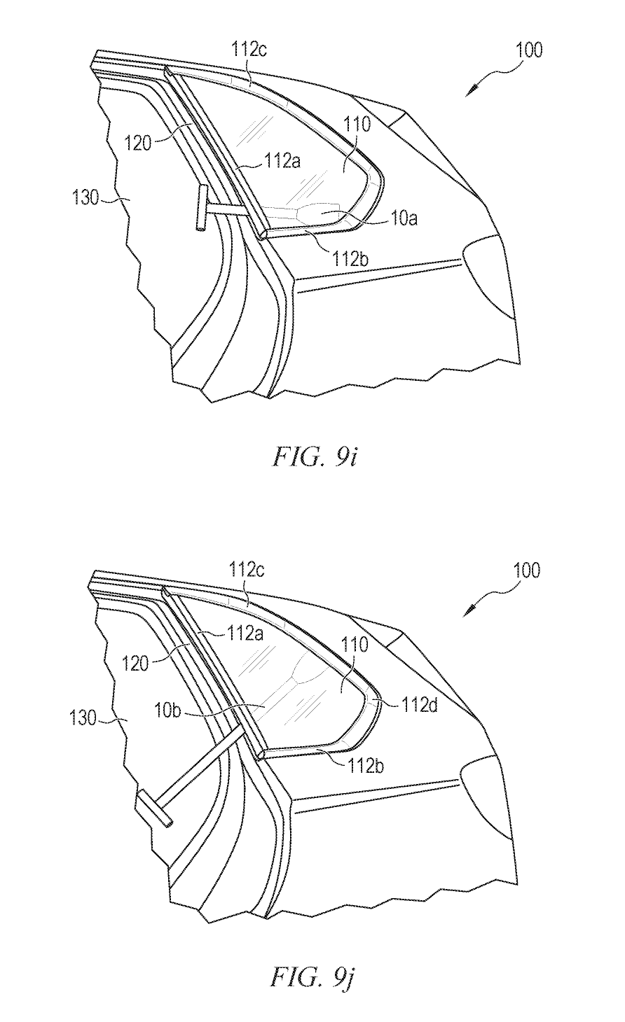

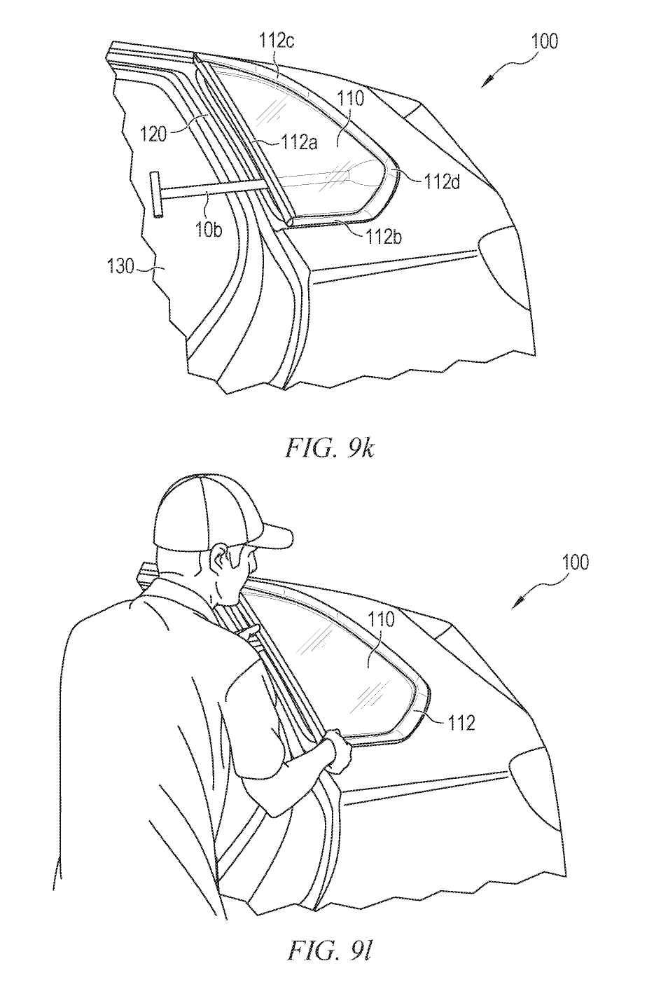

FIGS. 9a-9l illustrate the process of using bladed tools 10 to remove a quarter glass window from a vehicle. FIG. 9a illustrates a vehicle 100 including a quarter glass window 110 to be removed. Window 110 is encapsulated glass, and includes an encapsulant frame 112 around the perimeter of the window. Encapsulant frame 112 is formed around window 110 in a molding process, and can include fasteners, clips, gaskets, or other hardware embedded within the molding. Encapsulant frame 112 is usually formed from polyurethane or another polymer material. Clips embedded in frame 112 can be used to align window 110 on vehicle 100 by inserting the clips into openings of the vehicle's frame.

FIG. 9b illustrates a cross-sectional view of vehicle 100 through frame 112 of window 110. The portion of window 110 illustrated in FIG. 9b is near the edge of the window, and is surrounded by encapsulant frame 112. Portions of encapsulant frame 112 contact both the inside and outside of window 110. Encapsulant frame 112 wraps around the edges of window 110 such that the two portions of encapsulant frame 112 illustrated in FIG. 9b are connected outside the perimeter of the window.

Window 110 and encapsulant frame 112 are mechanically affixed to vehicle frame 120 by a urethane adhesive layer 124. Vehicle frame 120 is the main supporting structure of vehicle 100, which virtually all other components of the vehicle are attached to. Urethane seal 124 is applied as a bead around the perimeter of window 110 on encapsulant frame 112. Window 110 is then stuck onto vehicle frame 120 using urethane seal 124 as an adhesive. Urethane seal 124 can initially be applied to vehicle frame 120 if desired. Other types of adhesive are used to attach window 110 to vehicle frame 120 in other embodiments. In one embodiment, encapsulated frame 112 is not used, and urethane seal 124 is applied directly on window 110.

Urethane seal 124 provides an airtight and watertight seal to facilitate comfort of the driver and passengers of vehicle 100. However, urethane seal 124 makes removing window 110 more difficult by requiring that the adhesion of the urethane seal be broken. Breaking urethane seal 124 is where tools 10 come into play.

FIG. 9c illustrates beginning the process of removing window 110 using the shorter tool 10a. The rear door is open to provide access to the interface between edge 112a of frame 112 and the C pillar of vehicle frame 120. The rear door of vehicle 100 can also be completely removed if desired.

To begin the process of removing quarter glass window 110, a user inserts blade 40 of a tool 10 between vehicle frame 120 and the front edge 112a of frame 112. The removal process generally starts with edge 112a due to ease of access through door opening 130, even though urethane seal 124 normally extends continuously around the entire perimeter of window 110.

From the set of three tools 10a, 10b, and 10c illustrated in FIGS. 1a-1c, the shorter tool 10a is most appropriate for edge 112a. The shorter tool 10a fits lengthwise within the width of rear door opening 130, while leaving enough space to use a hammer or the user's body to apply force to the tool. While usable, the intermediate length tool 10b may or may not fit lengthwise depending on the width of door opening 130. However, even if tool 10b fits within door opening 130, there is unlikely to be enough room within the door opening behind handle 30 to hit the handle with a hammer or to fit the user's body behind the tool to apply a larger force. The longer tool 10c is unlikely to fit within door opening 130. While tool 10c is usable, a user of tool 10c would need to use the tool at a suboptimal angle.

With the sharpened edge 42 of blade 40 against urethane seal 124, a user applies a force F through handle 30 and shaft 20 to cut through the urethane seal. FIG. 9d illustrates the reverse view of FIG. 9c, i.e., urethane seal 124 on encapsulant frame edge 112a from the vehicle frame 120 side. Sharpened edge 42 of blade 40 is sharpened to cut through urethane seal 124. A spray of soapy water, or another lubricating substance, can be applied to window frame 112a, vehicle frame 120, urethane seal 124, and blade 40 to reduce friction from the urethane sticking to the blade. The lubricant may need to be reapplied periodically throughout the process of removing window 110.

The amount of force required will depend on the condition of urethane seal 124 and the sharpness of edge 42. A user may be able to cut through urethane seal 124 by just pushing on handle 30 with his or her hands, or leaning into the tool to apply force with their body weight. Using a corner of blade 40 as illustrated in FIG. 9e, rather than the entire sharpened edge 42, can help cut through urethane seal 124 easier by concentrating the applied force. If more significant force is required, an impact can be applied to handle 30. A user can apply an impact force with a clenched first or open palm. If needed, a hammer can be used to apply the impact to handle 30. FIG. 9f illustrates using hammer 140 to force blade 40 through urethane seal 124 between encapsulant frame 112a and vehicle frame 120.

Once tool 10a breaks through urethane seal 124, the user can then insert blade 40 through the broken portion of the urethane seal and apply force along the length of the urethane seal as shown in FIGS. 9g and 9h. Due to having already started the cut through urethane seal 124, tool 10a can generally be used to cut through the seal under edge 112a like a knife. A force is applied upward, which slides tool 10a vertically and extends the initial cut of urethane seal 124 along the entire length of edge 112a. If a moderate force applied with the user's hand is insufficient to continue the cut through urethane seal 124, an impact can be applied with the hand or hammer 140 to drive tool 10a upward.

FIG. 9h illustrates the reverse side of edge 112a, with blade 40 moving vertically through urethane seal 124. The user can grab shaft 20 with a second hand to apply a pulling force, while pushing handle 30 with the first hand, to keep blade 40 moving parallel to the length of urethane seal 124. FIG. 9h illustrates a total applied force F running parallel to urethane seal 124 rather than parallel to the length of shaft 20.

Blade 40 is driven upward to the top of edge 112a. If the initial cut was not at the bottom of edge 112a, a similar vertical cut can be made downward to the bottom of edge 112a. If cutting vertically as in FIGS. 9g and 9h proves challenging, additional horizontal cuts, as shown in FIGS. 9c-9f can be performed adjacent to the initial cut.

Once urethane seal 124 is completely cut under edge 112a, by any combination of vertical and horizontal cuts, the user begins working on the urethane seal at bottom edge 112b and top edge 112c of window frame 112. Completely breaking the seal of edge 112a is not technically necessary to begin bottom edge 112b and top edge 112c, but separation is created easier between window frame 112 and vehicle frame 120 if edge 112a is completed.

FIG. 9i illustrates tool 10a being used to cut through the lower urethane seal 124 under edge 112b. The cut is being performed parallel to the length of urethane seal 124 similarly to the cut in FIG. 9g, but in the horizontal direction. Again, force can be applied consistently using hand pressure, or an impact can be applied using a hand or hammer.

The flat aspect of shaft 20 allows the tool to extend between vehicle frame 120 and edge 112a of window frame 112 without requiring significant separation. In some embodiments, the thickness of blade 40 and shaft 20 in combination is less than the thickness of urethane seal 124, and no additional separation is required to insert tool 10 between window frame 112 and vehicle frame 120.

The user drives tool 10a along bottom edge 122b until the maximum depth of blade 40 is reached. The limiting factor is usually when handle 30 reaches window frame 112. When the length of the shorter tool 10a becomes insufficient for further cutting of urethane seal 124 under bottom edge 112b, the user switches to the intermediate length tool 10b. The user can either switch to tool 10b immediately, or use the shorter tool 10a on top edge 112c before switching tools.

FIGS. 9j and 9k illustrate using intermediate length tool 10b to finish cutting seal 124 toward the rear of vehicle 100. The intermediate length tool 10b is used to continue the cuts of seal 124 under bottom edge 112b and top edge 112c to back corner 112d once the length of shorter tool 10a has been exhausted for cutting both the top and bottom edges. Depending on the angle of bottom edge 112b and top edge 112c, portions of the top or bottom urethane seal 124 near the rear of the vehicle may need to be cut using cuts parallel to urethane seal 124 as shown in FIG. 9j. Finally, FIG. 9k illustrates completing the cut of urethane seal 124 by cutting the seal at back corner 112d of window frame 112. Depending on the angle of back corner 112d, another tool 10 with a narrower blade 40 may be used to reach the back corner without hitting vehicle frame 120 at the rear of window 110.

Intermediate length tool 10b is useful for the rear portions of seal 124 because, with the tool inserted between vehicle frame 120 and window frame 112 as seen in FIGS. 9j and 9k, the length of shaft 20 puts handle 30 in a convenient position to apply force, similar to when using the shorter tool 10a on edge 112a. The length of intermediate length tool 10b can be configured to place handle 30 approximately the same distance from edge 112a within door opening 130 when beginning to cut with tool 10b as tool 10a was to begin with.

As an example, if the shorter tool 10a is expected to be able to cut to a depth of at least ten inches past edge 112a in nearly all situations, then tool 10b can be made approximately ten inches longer than tool 10a. When beginning to cut with intermediate length tool 10b, blade 40 is inserted ten inches along lower edge 112b or upper edge 112c before continuing the cut, which places handle 30 in approximately the same position as when tool 10a was first used. Handle 30 remains in a useful location for applying force, while blade 40 is 10 inches further into window 110. The additional ten inches of length of tool 10b allows the user to cut ten additional inches of urethane seal 124 along lower edge 112b and upper edge 112c.

The longer tool 10c can be sized with a similar strategy, such that the length of tool 10c places handle 30 in approximately the same place when beginning to cut with the longer tool as the respective handles of shorter tool 10a and intermediate length tool 10b were when beginning the use of those tools. In the above example, longer tool 10c would be given an additional 10 inches of length over tool 10b, and 20 inches over the length of tool 10a.

The difference in lengths between tools 10a and 10b may not be exactly equal to the difference in lengths between tools 10b and 10c due to other circumstances. For instance, if tool 10c needs to be kept under 32 inches in length to be useful for a certain vehicle window, then tool 10c might only be eight inches longer than tool 10b even though tool 10b is ten inches longer than tool 10a. The difference in length from tool 10a to tool 10b will generally be kept approximately equal to the difference in length from tool 10b to tool 10c, e.g., within an inch or two.

The shorter tool 10a may have sufficient length to fully remove some narrower quarter glass with only the one tool. However, for most quarter glass, ease of use will be increased, and risk of damage will be reduced, by using the shorter tool 10a in combination with the intermediate length tool 10b.

Shorter tool 10a is more useful for portions of urethane seal 124 nearer door opening 130, while intermediate length tool 10b is more useful for portions of urethane seal 124 nearer the rear of vehicle 100. Using the two tools in combination maintains handle 30 at a location within door opening 130 where force is more easily applied. While using only the shorter tool 10a is possible, a user would not be able to easily reach the rear portions of urethane seal 124 by inserting the tool between vehicle frame 120 and window frame 112. A user may need to use tool 10a from within vehicle 100 to cut the rear portions of urethane seal 124, which gives a suboptimal angle for blade 40 relative to window 110.

Switching to the intermediate length tool 10b, which can reach the rear of window 110 when inserted between window frame 112 and vehicle frame 120, keeps the angle of blade 40 approximately perpendicular to the surfaces of the window frame and vehicle frame in contact with urethane seal 124. Keeping blade 40 perpendicular to the surfaces of window frame 112 and vehicle frame 120 reduces the likelihood that contact between the blade and frames will cause damage. The flat profile of handle 20 in tool 10b allows the tool to be inserted between vehicle frame 120 and window frame 112 without requiring additional separation relative to what was required for tool 10a.

Using only the intermediate length tool 10b is possible, but presents challenges in cutting urethane seal 124 under edge 112a because the handle 30 may extend out of door opening 130. Again, the angle of blade 40 would not be perpendicular to the surfaces of window frame 112 and vehicle frame 120, increasing the likelihood of damage. A user could remove window 110 with only intermediate length tool 10b, but using the set and switching tools is easier and less risky.

Once urethane seal 124 is cut around the entire perimeter of window 110, the window can be lifted out by hand as illustrated in FIG. 9l.

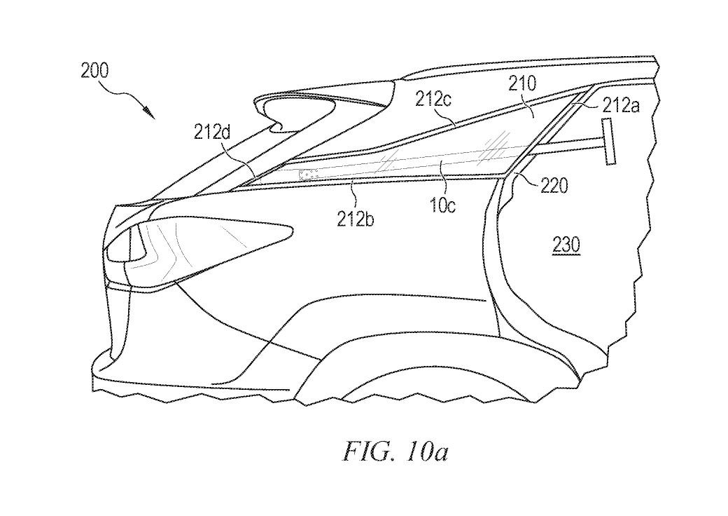

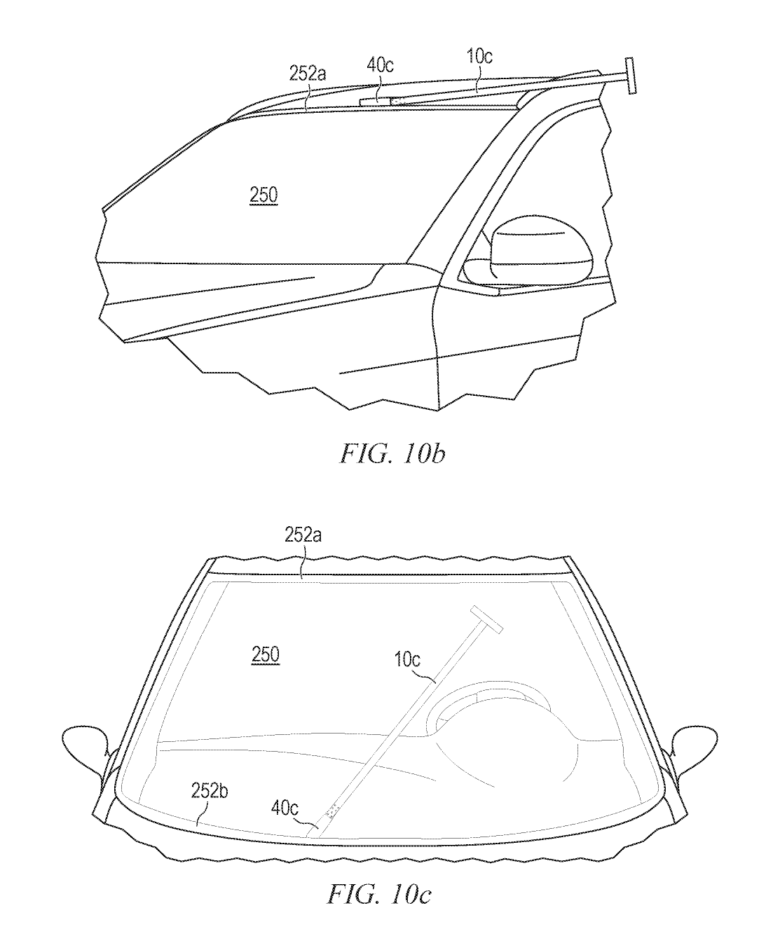

FIGS. 10a-10c illustrate situations where the longer tool 10c is useful. Some vehicles include quarter glass windows that are excessively long, e.g., vehicle 200 in FIG. 10a having quarter glass 210. Vehicle 200 is a hatchback, and quarter glass 210 extends nearly all the way from rear door opening 230 to the back end of the vehicle. To cut urethane seal 124 of such a deep window, all three tools 10a-10c can be used in combination. The shorter tool 10a is used to begin the cut at window frame edge 212a and nearby portions of bottom edge 212b and top edge 212c. The intermediate length tool 10b is used to cut through urethane seal 124 at bottom edge 212b and top edge 212c as far as the length of the intermediate length tool will allow. Then, intermediate length tool 10b is switched out for the longer tool 10c to reach back corner 212d and finish cutting through urethane seal 124, as shown in FIG. 10a. Using the three tools in combination allow the entirety of urethane seal 124 to be cut using a tool inserted between window frame 212 and vehicle frame 220.

FIGS. 10b and 10c illustrate using the longer tool 10c to remove a windshield 250. Longer tool 10c allows the user to reach the center of the windshield when standing beside the vehicle to conveniently cut the urethane seal along top edge 252a. The reduced width of blade 40c, giving more flexibility, helps the blade curve along with the curvature of edge 252a as the cut is made. The longer tool 10c also allows the user to reach the lower seal 252b while seated comfortably in the vehicle as shown in FIG. 10c. The flexibility of blade 40c allows tool 10c to reach lower seal 252 when the lower seal is not easily accessible from an angle perpendicular to windshield 250.

While one or more embodiments of the present invention have been illustrated in detail, the skilled artisan will appreciate that modifications and adaptations to those embodiments may be made without departing from the scope of the present invention as set forth in the following claims.

What is claimed:

1. A set of tools for removing a vehicle window, comprising:
a first tool including,
a first shaft comprising a substantially flat profile,
a first blade attached to the first shaft, and
a first handle attached to the first shaft opposite the first blade; and
a second tool including,
a second shaft comprising a substantially flat profile,
a second blade attached to the second shaft, wherein a second length of the second tool is longer than a first length of the first tool, and
a second handle attached to the second shaft opposite the second blade.

2. The set of tools of claim 1, wherein an edge of the first blade opposite the first shaft is sharpened.

3. The set of tools of claim 1, wherein an end of the first shaft oriented toward the first blade is rounded.

4. The set of tools of claim 1, further including a third tool comprising:
a third shaft comprising a substantially flat profile;
a third blade attached to the third shaft, wherein a third length of the third tool is longer than the second length of the second tool; and
a third handle attached to the third shaft opposite the third blade.

5. The set of tools of claim 4, wherein a difference between the first length and second length is approximately equal to a difference between the second length and third length.

6. The set of tools of claim 4, wherein a width of the third blade is less than a width of the first blade.

7. A tool for removing a vehicle window, comprising:
a shaft comprising a substantially flat profile;
a blade attached to a first end of the shaft; and
a handle attached to a second end of the shaft opposite the first end.

8. The tool of claim 7, further including a brace attached to the blade opposite the shaft.

9. The tool of claim 7, wherein the blade and shaft include a plurality of spot welds to mechanically attach the blade to the shaft.

10. The tool of claim 7, wherein the blade includes a tab extending toward the second end of the shaft.

11. The tool of claim 7, wherein an edge of the blade oriented away from the shaft is sharpened.

12. The tool of claim 7, wherein an end of the shaft oriented toward the blade is rounded.

13. A method of removing a window from a vehicle, comprising:
providing a first tool including,
a first shaft comprising a substantially flat profile, and
a first blade attached to the first shaft;
inserting the first blade into a gap between the window and vehicle; and
cutting a first portion of a seal between the window and vehicle using the blade by applying a force to the first tool.

14. The method of claim 13, further including:
providing a second tool comprising,
a second shaft including a substantially flat profile, and
a second blade, wherein a length of the second tool is longer than a length of the first tool;
inserting the second blade into the gap between the window and vehicle after cutting the first portion of the seal; and
cutting a second portion of the seal by applying a force to the second tool.

15. The method of claim 14, further including inserting the second tool through the first portion of the seal to cut the second portion of the seal.

16. The method of claim 14, wherein a width of the second blade is different from a width of the first blade.

17. The method of claim 14, further including:
providing a third tool comprising,
a third shaft comprising a substantially flat profile, and
a third blade, wherein a length of the third tool is longer than the length of the second tool;
inserting the third blade into the gap between the window and vehicle after cutting the second portion of the seal; and
cutting a third portion of the seal by applying a force to the third tool.

18. The method of claim 13, further including sharpening the first blade.

19. The method of claim 13, wherein applying the force to the first tool causes the tool to slide along the seal.

20. The method of claim 13, further including applying the force to the first tool using a hammer.
